(19) United States
(12) Patent Application Publication
(10) Pub. No.: US 2025/0156157 A1
(43) Pub. Date: May 15, 2025

(54) IDENTIFICATION AND GENERATION OF FUNCTION CALLS USING GENERATIVE MODEL

(71) Applicant: SAP SE, Walldorf (DE)

(72) Inventor: David KUNZ, Wilhelmsfeld (DE)

(21) Appl. No.: 18/508,514

(22) Filed: Nov. 14, 2023

(51) Int. Cl. G06F 8/35

(52) U.S. Cl. CPC G06F 8/35

(57) ABSTRACT

Systems and methods include reception of a user query in natural language from a user, determination of a system prompt including instructions to generate a search query, transmission of a user prompt based on the user query and the system prompt to a text generation model, reception of a generated function call search query from the text generation model, transmission of the generated function call search query to a repository of function call metadata, reception of first function call metadata from the repository in response to the search query, transmission of the first function call metadata and the user prompt to the text generation model to generate a first function call, and transmission of the first function call to an endpoint indicated by the function call metadata.

### BACKGROUND

Modern organizations often utilize a system landscape consisting of one or more software applications executing within one or more computing environments. For example, an organization may use applications deployed on computer servers located in on-premise data centers and within data centers provided by one or more platform-as-a-service (PaaS) providers. Any number of these computer servers may comprise cloud-based systems (e.g., providing services using scalable-on-demand virtual machines).

An organization may wish to add or enhance the functionality provided by an application. One approach requires changing the code of the application to implement the addition or enhancement, referred to herein as an extension. This approach can be problematic for several reasons. First, unless the application is specifically-designed to incorporate such extensions and the process for doing so is well-described, it can be quite difficult to customize a complex application authored by a different organization (i.e., the application provider). Even if the customization is feasible, the presence of the extension may hinder future updates to newer versions of the application.

Due to the foregoing difficulties, an organization may choose to extend the functionality of an existing application by creating a standalone extension application which calls an Application Programming Interface (API) implemented by the existing application. An API is a software interface which offers services to external applications. Use of the API by the extension application allows implementation of the extension without changing the code of the existing application.

An API specification describes function calls provided by the API, including their parameters, example parameter values, and example usages. A developer of the above-described extension application must study such an API specification to determine which functions to use and how to use them in order to obtain the desired result. However, conventional applications may offer many APIs, each of which may include many functions. Due to this abundance, it can be difficult for a developer to determine which APIs and function calls to use. The difficulty is exacerbated in a case that a particular desired result requires the use of more than one API and/or function call. For at least the foregoing reasons, a typical end-user is also unable to directly utilize APIs exposed by an application to obtain a desired result from that application.

Systems are desired to facilitate the identification and usage of API function calls to achieve a desired result.

### BRIEF DESCRIPTION OF THE DRAWINGS

FIG. 1 is a block diagram of a system to identify and generate a function call to respond to a user query according to some embodiments.

FIGS. 2A and 2B comprise a flow diagram of a process to identify and generate a function call to respond to a user query according to some embodiments.

FIG. 3 is a view of a user interface for submitting a user query according to some embodiments.

FIG. 4 illustrates a user prompt and a system prompt according to some embodiments.

FIG. 5 is a block diagram illustrating generation of function call metadata embeddings according to some embodiments.

FIG. 6 illustrates a user prompt and a system prompt according to some embodiments.

FIG. 7 illustrates a user prompt and a system prompt according to some embodiments.

FIG. 8 is a view of a user interface for submitting a user query and receiving a response according to some embodiments.

FIG. 9 comprises a flow diagram of a process to identify and generate one or more function calls to respond to a user query according to some embodiments.

FIG. 10 illustrates a user prompt and a system prompt according to some embodiments.

FIG. 11 illustrates a user prompt and a system prompt according to some embodiments.

FIG. 12 is a block diagram of a system to identify function call metadata in response to a developer query according to some embodiments.

FIG. 13 is a view of an interface for submitting a query and receiving a response according to some embodiments.

FIG. 14 is a block diagram of a cloud-based system to identify and generate one or more function calls to respond to a user query according to some embodiments.

### DETAILED DESCRIPTION

The following description is provided to enable any person in the art to make and use the described embodiments. Various modifications, however, will be readily-apparent to those in the art.

Embodiments may provide efficient identification and generation of function calls from a plurality of available function calls using a trained text generation model. Embodiments may provide such identification and generation without requiring prompting of the text generation model with information describing the available function calls. Embodiments may thereby identify function calls from any number of available function calls regardless of any input token restrictions of the text generation model.

Briefly, a natural language query is received from a user, and a system prompt including instructions to generate a search query is transmitted to a text generation model along with a user prompt which includes or is based on the natural language query. In response, a function call search query is generated by and received from the text generation model. The generated function call search query is transmitted to a repository of function call metadata and first function call metadata is received from the repository in response to the search query.

Next, the first function call metadata and the user prompt are transmitted to the text generation model to generate a first function call. The first function call is transmitted to an endpoint indicated by the function call metadata. According to some embodiments, a first response is received from the endpoint, the first response and the user prompt are transmitted to the text generation model, a query result is received from the text generation model in response to the user prompt and the first response, and the query result is presented to the user.

Embodiments may therefore identify function call metadata from the metadata of a variety of function calls which are currently stored in the repository, rather than from stale and token-limited information provided within a system prompt. Moreover, the system receiving the user query may handle authentication with the called endpoint.

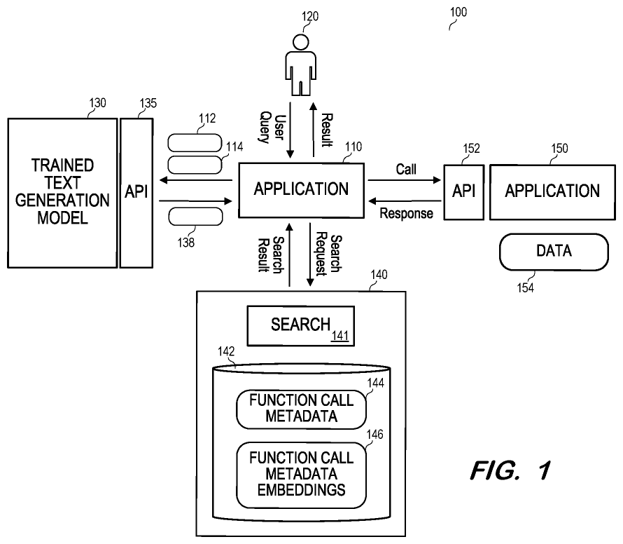

FIG. 1 is a block diagram of system 100 to identify and generate a function call for responding to a user query according to some embodiments. Each of the illustrated components may be implemented using any suitable combination of computing hardware and/or software that is or becomes known. Such combinations may include cloud-based implementations in which computing resources are virtualized and allocated elastically. In some embodiments, two or more components are implemented by a single computing device or virtual machine.

More particularly, embodiments may be on-premise, cloud-based, distributed (e.g., with distributed storage and/or compute nodes) and/or deployed in any other suitable manner. Each computing system described herein may comprise disparate cloud-based services, a single computer server, a cluster of servers, and any other combination that is or becomes known. All or a part of each system may utilize Infrastructure-as-a-Service (IaaS), Platform-as-a-Service (PaaS) and/or Software-as-a-Service (SaaS) offerings owned and managed by one or more different entities as is known in the art.

Application 110 may comprise program code executable by an application platform (e.g., a runtime environment) to cause the actions described herein. The application platform may include an operating system, services, I/O, storage, libraries, frameworks, etc. to applications executing therein. In some examples, user 120 accesses a user interface of application 110 to submit a user query thereto.

In response to the user query, application 110 generates user prompt 112 and system prompt 114 and transmits prompts 112 and 114 to trained text generation model 130. Model 130 may comprise a neural network trained to generate text based on input text. Trained text generation model 130 may be implemented by a set of linear equations, executable program code, a set of hyperparameters defining a model structure and a set of corresponding weights, or any other representation of an input-to-output mapping which was learned as a result of the training.

According to some embodiments, model 130 is a large language model (LLM) conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of trained text generation model 130 include GPT, LaMDA, Claude or the like. Model 130 may be publicly available or deployed within a landscape which is trusted by a provider of system 100. Similarly, text generation model 130 may be trained based on public and/or private data. Text generation model 130 exposes API 135 for providing prompts 112 and 114 thereto and receiving generated text 138 therefrom as is known in the art.

Application 110 transmits search requests to and receives search results from repository 140. Repository 140 may comprise any searchable data storage system, including but not limited to a monolithic or distributed database system. Repository 140 includes search component 141 which is exposed to external processes to submit search queries to search for data stored in storage 142. According to the illustrated embodiment, storage 142 stores function call metadata 144 and function call metadata embeddings 146.

Function call metadata 144 may comprise metadata describing a plurality of function calls. The metadata associated with a function call may include, for example, a function name, function parameters (i.e., arguments), descriptions of the function name and function parameters, and an endpoint supporting the function call. For purposes of the present description, an API may consist of one or more function calls associated with a same endpoint. Function call metadata may therefore comprise one or more publicly-available API specifications.

The function calls described by function call metadata 144 may be provided by one or more applications and/or services. Some of the function calls may be supported by a particular database system of a particular software provider, while others of the function calls may be supported by a procurement application provided by the particular software provider. The function calls may also be supported by applications and/or services provided by more than one software provider.

Function call metadata embeddings 146 are multi-dimensional vector representations of function call metadata 144. Function call metadata embeddings 146 facilitate searches for function call metadata 144 which is semantically similar to search terms of a given search request. Generation and use of function call metadata embeddings 146 according to some embodiments will be described in detail below.

Application 150 may comprise any functionality that is or becomes known, including functionality based on data 154. Application 150 may comprise a database application and data 154 may comprise a corresponding database. Certain functions of application 150 are callable by external applications such as application 110 via API 152.

Function call metadata 144 may describe a function call supported by API 152. As will also be described below, application 110 may receive such a function call as generated by model 130 and transmit the generated function call to API 152. Application 150 executes the function call and provides a response to application 110. Application 110 then provides a result to user 120 based on the response, with or without assistance from model 130 as will be described below.

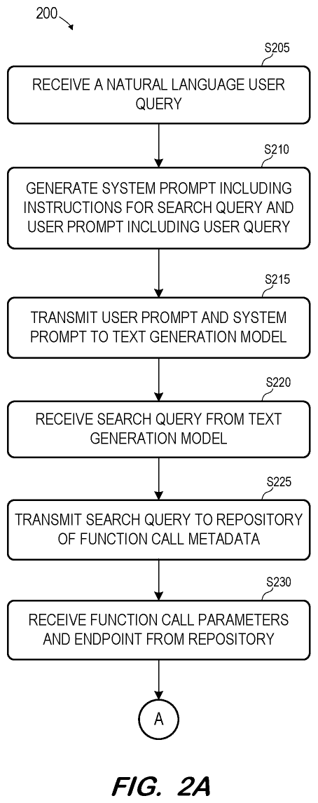

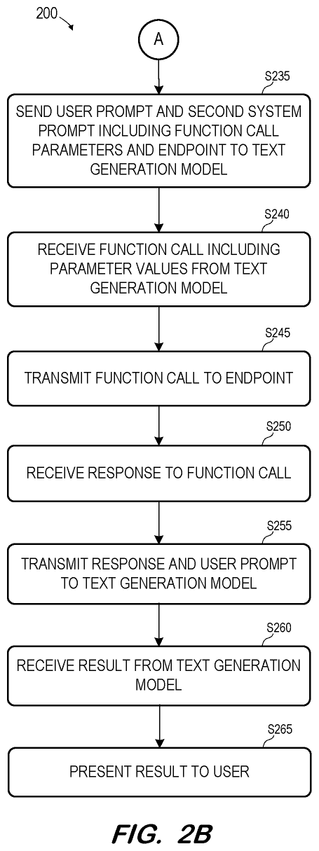

FIGS. 2A and 2B comprise a flow diagram of process 200 to identify and generate a function call to respond to a user query according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any one or more processing units, including but not limited to a microprocessor, a microprocessor core, and a microprocessor thread. In some embodiments, process 200 may be embodied by program code of a plug-in which may be re-used by different applications. Embodiments are not limited to the examples described below.

A user query is initially received at S205. The user query may be in natural language form, rather than conforming to any technical query format. The user query may be received by an application executing process 200 from a client application operated by a user. The client application may comprise a Web browser, a JavaScript application executing within a virtual machine of a Web browser and/or any other suitable type of client application.

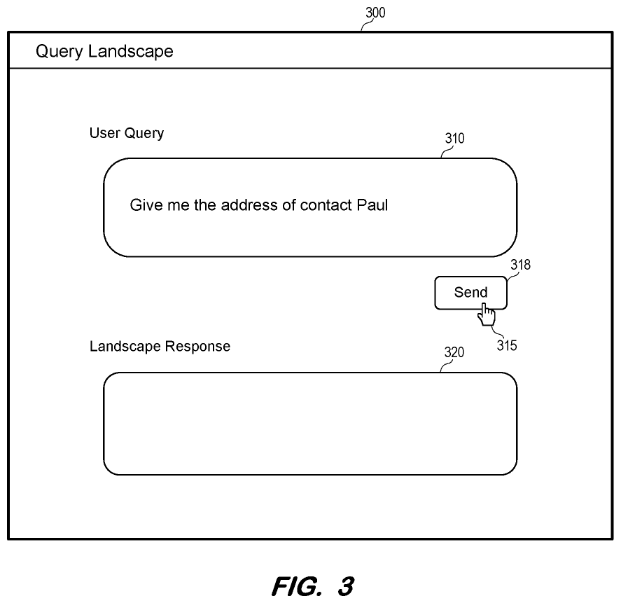

FIG. 3 illustrates interface 300 of an application according to some embodiments. In one example, a user operates a Web browser to access an application via a corresponding Uniform Resource Locator (URL) and the application returns an interface such as interface 300. According to some embodiments, interface 300 is presented by a device executing a client application (e.g., a Web application) which communicates with an application provided by a cloud-based system.

Interface 300 includes user query input field 310. As illustrated, a user has entered the natural language user query “Give me the address of contact Paul” into field 310. The user then operates cursor 315 to select Send control 318, causing the user query to be received at S205.

Next, a system prompt and a user prompt are generated at S210. The system prompt includes instructions to generate a search query. The user prompt may simply comprise a copy of the received natural language user query, although embodiments are not limited thereto. For example, any suitable formatting, correction or other processing may be applied to the received user query in order to generate the user prompt.

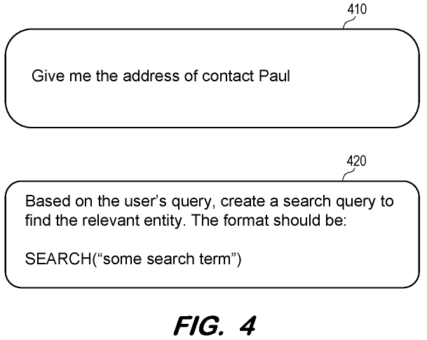

FIG. 4 illustrates user prompt 410 and system prompt 420 generated at S210 according to some embodiments. In the present example, user prompt 410 simply includes the received natural language user query. System prompt 420 includes instructions for generating a search query to find an entity relevant to user prompt 410. Embodiments are not limited to the particular language of system prompt 420. Many other system prompts may be generated at S420 which include instructions for generating a search query to find an entity relevant to the user's query. The text of the generated system prompt, as well as of the generated user prompt, may depend on the identity and type of the text generation model to which the prompts will be transmitted.

The system prompt and the user prompt are transmitted to a text generation model at S215. In one example, of S215, the system prompt and the user prompt are transmitted from application 110 to text generation model 130 of system 100. The system prompt and the user prompt may be transmitted via API 135 exposed by model 130. The system prompt and the user prompt may be transmitted separately or together. If transmitted together, each prompt may be identified as either the system prompt or the user prompt, but embodiments are not limited thereto.

In response to the input user prompt and the system prompt, the text generation model operates as configured by its training to generate a search query based on the system prompt and the user prompt. According to the present example, the search query SEARCH (“contact”) may be generated and returned, where it is received at S220.

The search query is transmitted to a repository of function call metadata (e.g., repository 140) at S225. An endpoint and parameters of a function call are received from the repository at S230. According to some embodiments, the endpoint and parameters of the function call are determined based on embeddings of the search terms (e.g., “contact”) of the search query and on function call metadata embeddings which were previously generated and stored in the repository.

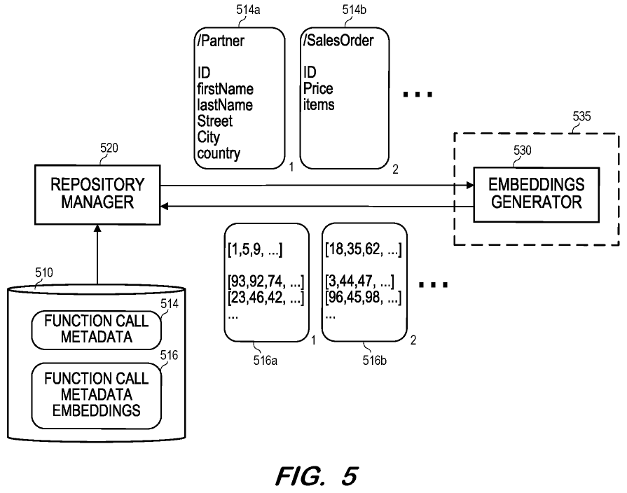

FIG. 5 is a block diagram illustrating generation of function call metadata embeddings according to some embodiments. Repository 510 stores function call metadata 514 including parameters, endpoints and descriptions of various function calls. Function call metadata 514 may comprise one or more API specifications as described above. Repository manager 520 may be executed to manage the generation of function call metadata embeddings 516 for use during process 200 as described above.

For example, repository manager 520 may retrieve all or a subset of function call metadata and transmit the retrieved metadata to embeddings generator 530. Each of function call metadata 514a and 514b represents a “chunk” consisting of, in text format, the endpoint and parameters of a single function call. Chunks 514a and 514b are indexed as “1” and “2” to identify the function calls with which they are associated.

Embeddings generator 530 may comprise any suitable component to map text of received chunks to a multi-dimensional vector space which is identical or similar to the multi-dimensional vector space used by the text generation model. In some embodiments, embeddings generator 530 is accessible via an exposed endpoint of the text generation model itself (e.g., component 535). According to some embodiments, embeddings generator 530 is a component of repository manager 520.

Embeddings generator 530 generates and returns function call metadata embeddings 516a and 516b corresponding to function call metadata 514a and 514b. Function call metadata embeddings 516a and 516b are also indexed as “1” and “2” to identify the function calls (and the function call metadata) with which they are associated. Repository manager 520 stores function call metadata embeddings 516a and 516b in function call metadata embeddings 516, in a manner which associates a given function call metadata embedding 516 with the function call metadata 514 from which it was generated.

In some examples, the search query transmitted to the repository at S225 represents the search term received from the text generation model at S220 in a text format and the repository generates the embedding as described with respect to FIG. 5. In other examples, the search query transmitted to the repository at S225 includes an embedding (i.e., a multi-dimensional numerical vector representation) of the search term. This embedding may have been received from the text generation model with the search query at S220, or the component executing process 200 may generate the embedding from a text search term received at S220. The component executing process 200 may generate such an embedding in any manner described above, including by calling an embeddings generation endpoint of the text generation model.

According to some embodiments, reception of the search query at the repository triggers a similarity search. More specifically, the embedding of the search term is compared with the function call metadata embeddings to determine a most-similar function call metadata embedding, according to any measure of similarity between two multi-dimensional numerical vectors that is or becomes known. The function call metadata associated with the most-similar function call metadata embedding is then identified and returned at S230.

For example, it is assumed that the embedding of search term “contact” consists of multi-dimensional numerical vector [1,5,10, . . . ]. The repository is therefore searched for an embedding which is most-similar to embedding [1,5,10, . . . ]. In the present example, it is determined that embedding [1,5,9, . . . ] of function call metadata embedding chunk 516a is most-similar to embedding [1,5,10, . . . ], and that function call metadata 514a is associated with embedding [1,5,10, . . . ]. Accordingly, function call metadata 514a is returned at S230.

In some embodiments, the repository search identifies a chunk of function call metadata embeddings (e.g., chunk 516a, chunk 516b) which is most-similar to the embedding of the search term. This identification takes into account all of the embeddings of a chunk of function call embeddings to determine similarities between the embedding of the search term and each chunk of function call embeddings.

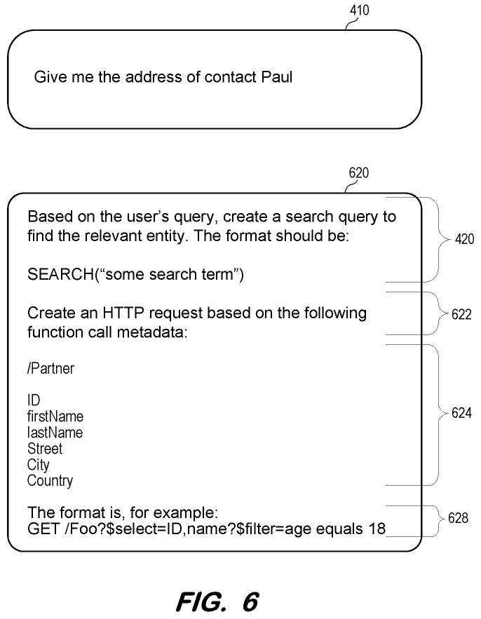

After receipt of the function call parameters and endpoint at S230, the user prompt and a second system prompt are transmitted to the text generation model at S235. FIG. 6 shows previously-described user prompt 410 and second system prompt 620 which are sent to the text generation model at S235 according to the present example. Second system prompt 620 includes the text of previously-generated system prompt 420, instruction 622, function call parameters and endpoint text 624 and example function call format 628. Notably, generation of second system prompt 620 at S235 requires very little logic, since system prompt 420, instruction 622 and example function call format 628 may be hard-coded, and text 624 is generated on-the-fly by directly copying the function call parameters and endpoint which were received at S230.

A function call is received from the text generation model at S240 in response to the user prompt and second system prompt. The function call includes the parameter values and is formatted as specified by the second user prompt. In the present example, the function call may comprise “GET/Partner$select=street, city, country&filter=firstName equals Paul”.

In some embodiments, S230 includes identifying and returning the function call parameters and endpoints associated with several chunks function call metadata embeddings which are most-similar to the embedding of the search term. In such a case, the second system prompt may include each of such function call parameters and endpoints, thereby allowing the text generation model to select from among several function calls to generate.

The function call is transmitted to an endpoint indicated by the function call metadata at S245. Transmission of the function call may initially comprise authenticating the user with the endpoint. For example, user 120 may provide credentials in order to log on to application 110 and receive a token in return. The token may be passed to application 110 with the user query and used to authenticate with the endpoint prior to transmitting the function call thereto at S245.

A response to the function call is received from the endpoint at S250. The response may comprise structured data such as:
{
   Street: “Foostreet”,
   city: “Walldorf”,
   Country: “Germany”
}

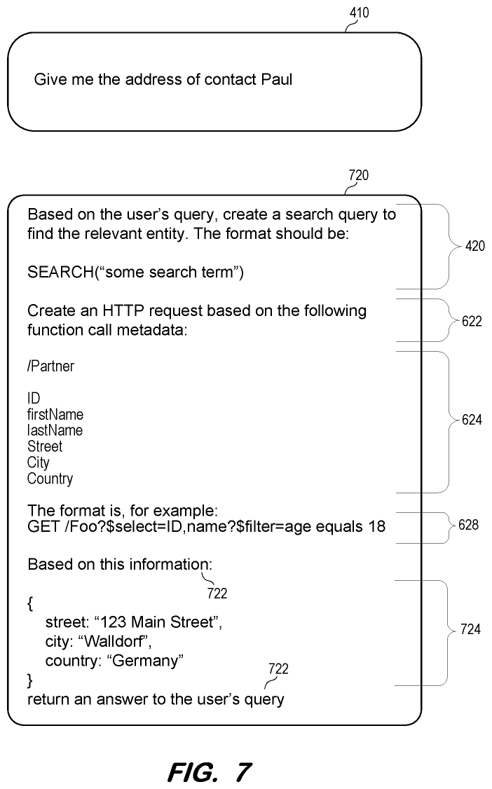

Next, at S255, the received response and the user prompt are transmitted to the text generation model. The received response may be transmitted within a system prompt as shown in FIG. 7. System prompt 720 includes the text of previously-generated system prompt 420, instruction 622, function call parameters and endpoint text 624 and example function call format 628. System prompt 720 also includes instruction text 722 and response 724 returned from the endpoint. Again, generation of system prompt 720 requires very little logic, since instruction text 722 may be hard-coded, and response 724 may simply be copied from the response received at S250.

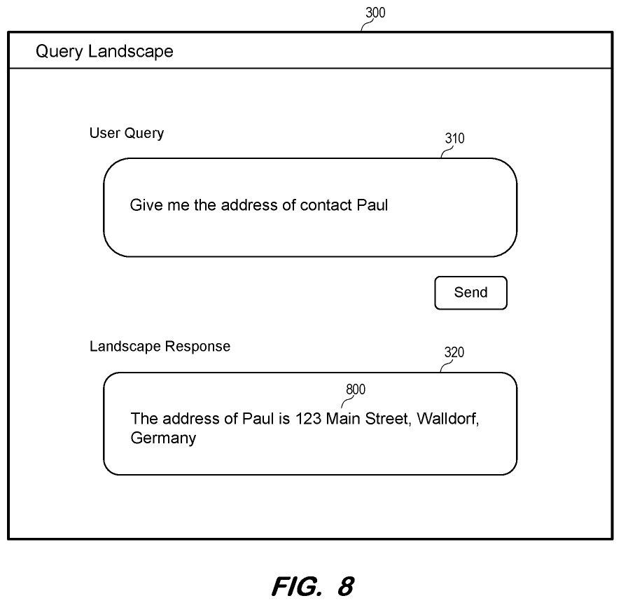

A result is received from the text generation model at S260, and the result is presented to the user at S265. FIG. 8 illustrates user interface 300 in which result 800 is presented in area 320. Result 800 may be a copy of the result received from the text generation model at S260 or may be otherwise based on the received result. For example, sensitive data may be filtered from or the result or obscured prior to presenting the result to the user. Sensitive data may include, but is not limited to, Personally Identifiable Information, secret data, privileged data, hate speech, and bias language.

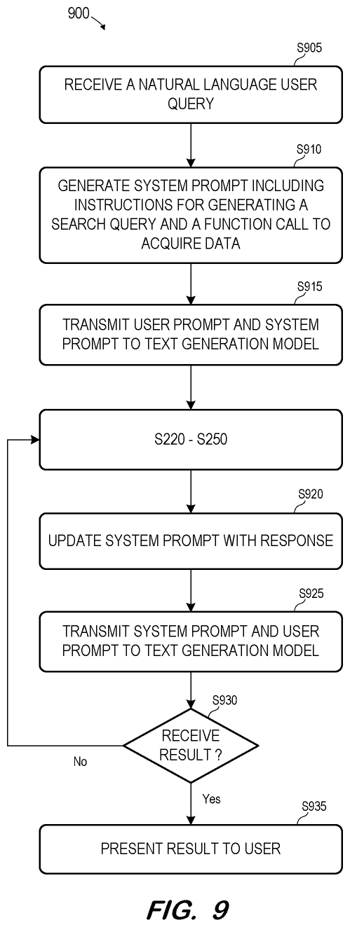

FIG. 9 is a flow diagram of process 900 according to some embodiments. Process 900 advantageously allows for identification and generation of multiple chained function calls, in which the result of one function call is received and used to populate the parameters of a subsequent function call. Two or more of the chained function calls may be directed to endpoints exposed by different applications and/or to different endpoints exposed by the same application.

A user query is initially received at S905, for example as described above with respect to S205. Next, a system prompt and a user prompt are generated at S910. The system prompt includes instructions for generating a search query and instructions for generating a function call to acquire data.

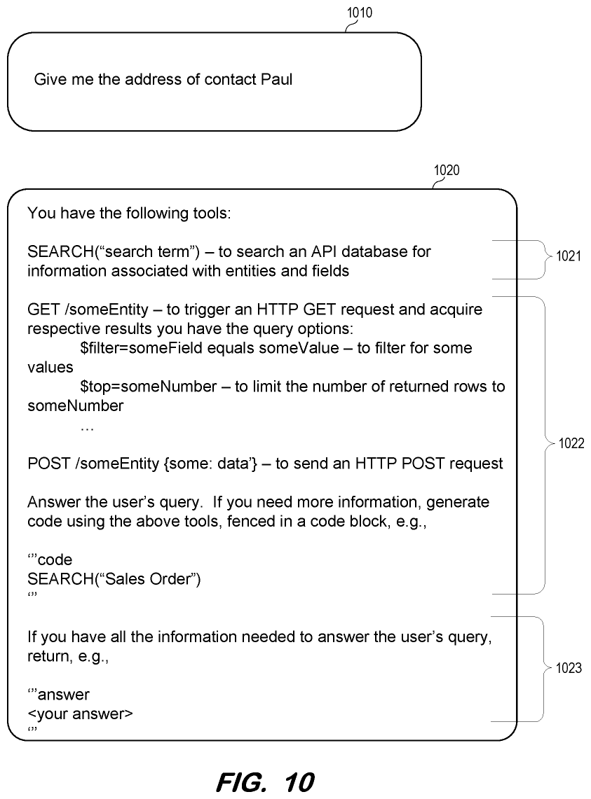

FIG. 10 illustrates user prompt 1010 and system prompt 1020 generated at S910 according to some embodiments. User prompt 1010 includes a copy of the user query received at S905. System prompt 1020 includes instructions 1021 for generating a search query to find information associated with entities and fields. System prompt 1020 also includes instructions 1022 for generating a function call to acquire data. Lastly, system prompt 1020 includes instructions 1023. Embodiments are not limited to the text of system prompt 1020. Rather, embodiments include any system prompt text which results in the functionality described herein.

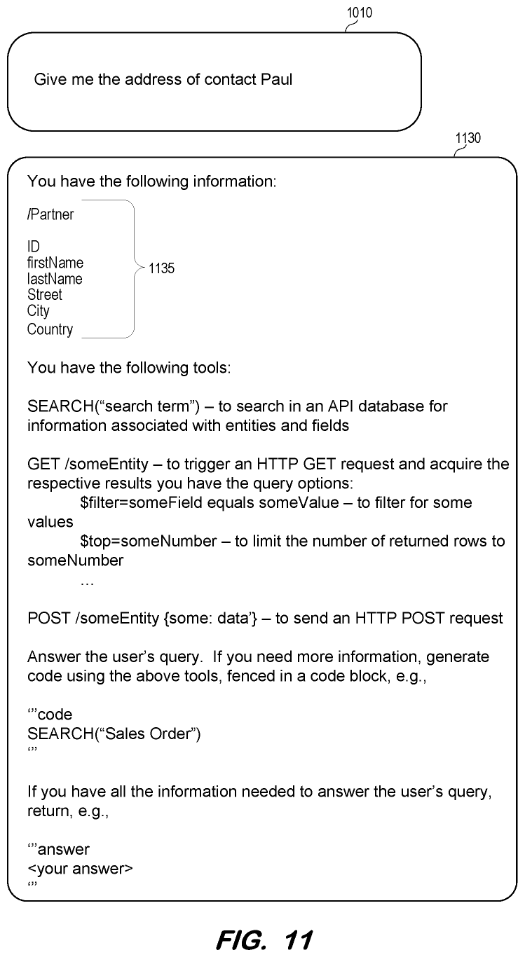

The user prompt and system prompt are transmitted to a text generation model at S915. Next, flow proceeds as described above with respect to S220 through S250 of process 200, to receive a response from a function call endpoint. The system prompt is updated with the response at S920. For example, FIG. 11 shows updated system prompt 1130 including response 1135 received from a function call endpoint as described above.

The user prompt and updated system prompt are transmitted to the text generation model at S925. Based on the instructions of the updated system prompt, the text generation model either returns a result, a generated function call, or a generated search query. In the example of updated system prompt 1130, the text “If you need more information, generate code using the above tools” and “If you have all the information needed to answer the user's query, return, e.g.,” instructs the text generation model to determine whether is able to answer the user's query and, if so, to return a result. If not, the text generation model generates and returns a function call if it already has its needed the function call metadata, or a search query to obtain needed function call metadata as described above.

Assuming that a search query is returned from the text generation model after S925, flow returns from S930 to S220 to receive the search query. Flow may continue to cycle in this manner to transmit one or more additional function calls to various endpoints until it is determined at S930 that a result has been received from the text generation model. The result is presented to the user at S935 as described above.

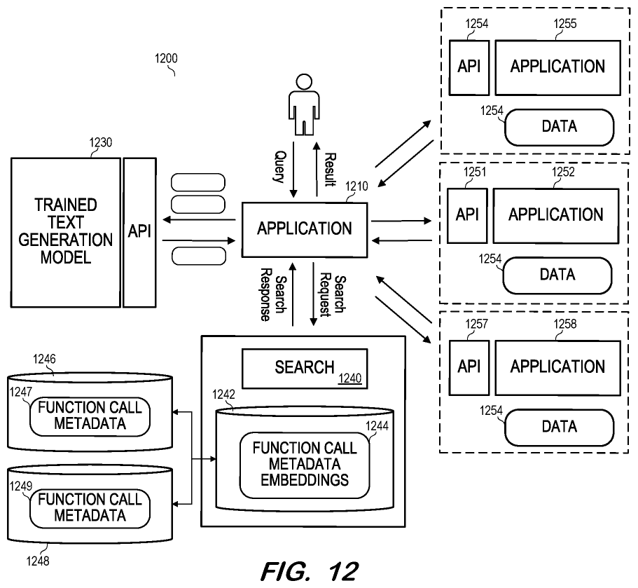

FIG. 12 is a block diagram of system 1200 according to some embodiments. System 1200 includes multiple applications 1252, 1255 and 1258 providing APIs 1251, 1254 and 1257 for accessing function calls specified in function call metadata 1247 and function call metadata 1249.

In particular, system 1200 includes function call metadata 1247 and function call metadata 1249 stored in storage devices 1246 and 1248, respectively. The function calls described by function call metadata 1247 and function call metadata 1249 may be supported by respective applications and/or service providers. Function call metadata embeddings 1244 may be generated and stored in storage device 1242 based on function call metadata 1247 and function call metadata 1249. Accordingly, search component 1240 may identify function call metadata from either of function call metadata 1247 and function call metadata 1249 in response to a model-generated search request received from application 1210.

Consequently, trained text generation model 1230 may generate function calls for endpoints exposed by API 1254, API 1251 or API 1257. These function calls may be chained to answer a single user query as described above with respect to process 900. More particularly, two or more of the chained function calls may be transmitted to different endpoints and executed by different ones of applications 1252, 1255 and 1258.

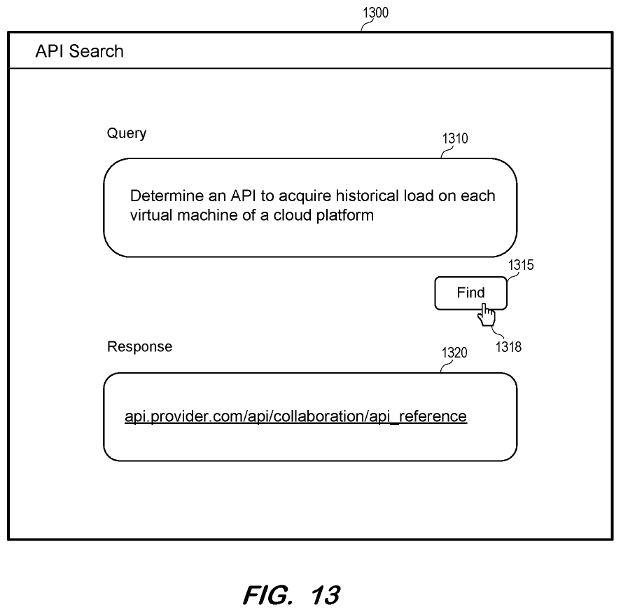

Some embodiments may be executed to identify function calls without generating or executing such function calls. For example, a code developer may wish to identify a function call providing particular functionality to use within a software application. An integrated development environment used by the code developer may provide a user interface such as user interface 1300 of FIG. 13 to facilitate such identification.

For example, the developer inputs a query for identifying an API into input field 1310. The developer then selects Find control 1315 using cursor 1318. In response, S210 through S230 are executed to search for and receive corresponding function call metadata from a repository. In the present example, the repository associates function call metadata with URLs including the function call metadata, and the URL including the identified function call metadata is presented to the developer in area 1320 of interface 1300 as shown in FIG. 13.

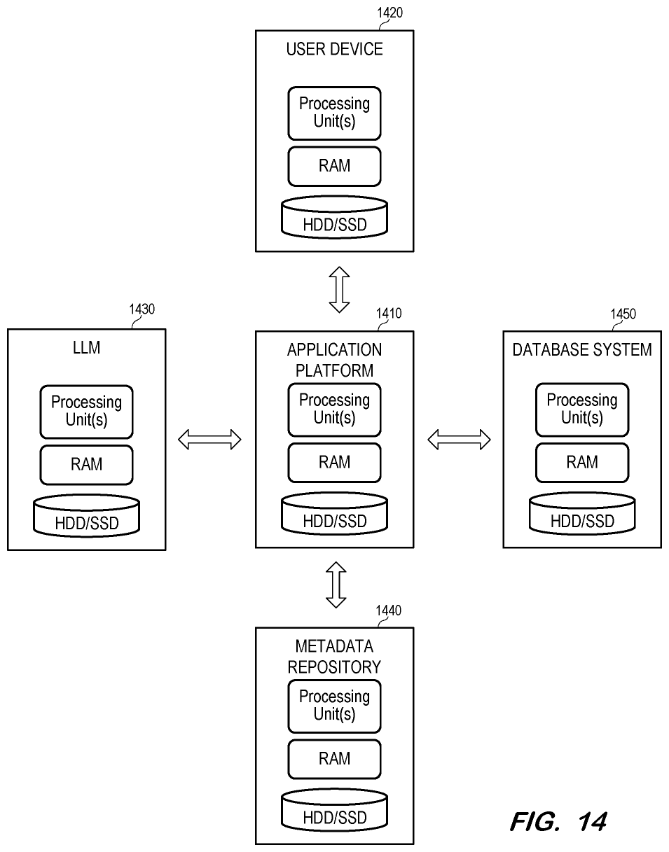

FIG. 14 is a block diagram of a cloud-based system according to some embodiments. In this regard, application platform 1410, LLM 1430, metadata repository 1440 and database system 1450 may comprise cloud-based compute resources, such as virtual machines, allocated by a cloud provider providing self-service and immediate provisioning, autoscaling, security, compliance and identity management features.

User device 1420 may interact with a user interface of an application executing on application platform 1410, for example via a Web browser executing on user device 1420. The application may receive a natural language user query via the user interface and operate as described above to receive a search query from LLM 1430, to transmit the search query to metadata repository 1440, to receive function call metadata from repository 1440, to transmit the function call metadata to LLM 1430, to receive a generated function call from LLM 1430, to transmit the generated function call to database system 1450, to receive a response from database system 1450, to transmit the response to LLM 1430, to receive a result from LLM 1430, and to return the result to user device 1420.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing executable program code; and
at least one processing unit to execute the program code to cause the system to:
receive a user query in natural language from a user;
determine a system prompt including instructions to generate a search query;
transmit a user prompt based on the user query and the system prompt to a text generation model;
receive a generated function call search query from the text generation model;
transmit the generated function call search query to a repository of function call metadata;
receive first function call metadata from the repository in response to the search query;
transmit the first function call metadata and the user prompt to the text generation model to generate a first function call; and
transmit the first function call to an endpoint indicated by the function call metadata.

2. The system of claim 1, wherein transmission of first function call metadata and the user prompt includes transmission of a second system prompt including instructions to generate a function call.

3. The system of claim 1,
wherein the received first function call metadata comprises one or more numerical vectors, and
wherein transmission of the first function call metadata and the user prompt to the text generation model to generate a first function call comprises:
transmission of the one or more numerical vectors to an embedding endpoint of the text generation model; and
receipt of the first function call metadata from the embedding endpoint of the text generation model in response to the one or more numerical vectors.

4. The system of claim 1, at least one processing unit to execute the program code to cause the system to:
receive a response to the first function call from the endpoint;
transmit the response to the text generation model;
transmit the user prompt and a second system prompt including the response to the text generation model;
receive a second generated function call search query from the text generation model in response to the user prompt and the second system prompt;
transmit the second generated function call search query to the repository of function call metadata;
receive second function call metadata from the repository in response to the second generated function call search query;
transmit the second function call metadata and the user prompt to the text generation model to generate a second function call; and
transmit the second function call to a second endpoint indicated by the second function call metadata.

5. The system of claim 4,
wherein the received first function call metadata comprises one or more numerical vectors, and
wherein transmission of the first function call metadata and the user prompt to the text generation model to generate a first function call comprises:
transmission of the one or more second numerical vectors to an embedding endpoint of the text generation model; and
receipt of the first function call metadata from the embedding endpoint of the text generation model in response to the one or more numerical vectors.

6. The system of claim 4, the at least one processing unit to execute the program code to cause the system to:
receive a second response from the second endpoint;
transmit the user prompt and the second response to the text generation model;
receive a query result from the text generation model in response to the user prompt and the second response; and
present the query result to the user.

7. The system of claim 1, the at least one processing unit to execute the program code to cause the system to:
receive a response from the endpoint;
transmit the user prompt and the response to the text generation model;
receive a query result from the text generation model in response to the user prompt and the response; and
present the query result to the user.

8. A method comprising:
receiving a user query from a user;
determining a system prompt including instructions to generate a search query;
transmitting a user prompt including the user query and the system prompt to a text generation model;
receiving a generated search query from the text generation model;
transmitting the generated search query to a repository of function call metadata;
receiving first function call metadata from the repository in response to the search query;
transmitting the first function call metadata and the user prompt to the text generation model to generate a first function call;
transmitting the first function call to an endpoint indicated by the function call metadata; and
receiving a response to the first function call from the endpoint.

9. The method of claim 8, wherein transmitting the first function call metadata and the user prompt includes transmitting a second system prompt including instructions to generate a function call.

10. The method of claim 8,
wherein the received first function call metadata comprises one or more numerical vectors, and
wherein transmitting the first function call metadata and the user prompt to the text generation model to generate a first function call comprises:
transmitting the one or more numerical vectors to an embedding endpoint of the text generation model; and
receiving the first function call metadata from the embedding endpoint of the text generation model in response to the one or more numerical vectors.

11. The method of claim 8, further comprising:
transmitting the response to the text generation model;
transmitting the user prompt and a second system prompt including the response to the text generation model;
receiving a second generated search query from the text generation model in response to the user prompt and the second system prompt;
transmitting the second generated search query to the repository of function call metadata;
receiving second function call metadata from the repository in response to the second generated search query;
transmitting the second function call metadata and the user prompt to the text generation model to generate a second function call;
transmitting the second function call to a second endpoint indicated by the second function call metadata; and
receiving a second response from the second endpoint in response to the second function call.

12. The method of claim 11,
wherein the received first function call metadata comprises one or more numerical vectors, and
wherein transmitting the first function call metadata and the user prompt to the text generation model to generate a first function call comprises:
transmitting the one or more numerical vectors to an embedding endpoint of the text generation model; and
receiving the first function call metadata from the embedding endpoint of the text generation model in response to the one or more numerical vectors.

13. The method of claim 11, further comprising:
transmitting the user prompt and the second response to the text generation model;
receiving a query result from the text generation model in response to the user prompt and the second response; and
presenting the query result to the user.

14. The method of claim 8, further comprising:
transmitting the user prompt and the response to the text generation model;
receiving a query result from the text generation model in response to the user prompt and the response; and
presenting the query result to the user.

15. A non-transitory medium storing program code executable by at least one processing unit of a computing system to cause the computing system to:
receive a user query from a user;
determine a system prompt including instructions to generate a search query;
transmit a user prompt including the user query and the system prompt to a text generation model;
receive a generated search query from the text generation model;
transmit the generated search query to a repository of function call metadata;
receive first function call metadata from the repository in response to the search query;
transmit the first function call metadata and the user prompt to the text generation model to generate a first function call;
transmit the first function call to an endpoint indicated by the function call metadata; and
receive a response to the first function call from the endpoint.

16. The medium of claim 15,
wherein the received first function call metadata comprises one or more numerical vectors, and
wherein transmission of the first function call metadata and the user prompt to the text generation model to generate a first function call comprises:
transmission of the one or more numerical vectors to an embedding endpoint of the text generation model; and
receipt of the first function call metadata from the embedding endpoint of the text generation model in response to the one or more numerical vectors.

17. The medium of claim 15, the program code executable by at least one processing unit of a computing system to cause the computing system to:
transmit the response to the text generation model;
transmit the user prompt and a second system prompt including the response to the text generation model;
receive a second generated search query from the text generation model in response to the user prompt and the second system prompt;
transmit the second generated search query to the repository of function call metadata;
receive second function call metadata from the repository in response to the second generated search query;
transmit the second function call metadata and the user prompt to the text generation model to generate a second function call;
transmit the second function call to a second endpoint indicated by the second function call metadata; and
receive a second response from the second endpoint in response to the second function call.

18. The medium of claim 17,
wherein the received first function call metadata comprises one or more second numerical vectors, and
wherein transmission of the first function call metadata and the user prompt to the text generation model to generate a first function call comprises:
transmission of the one or more numerical vectors to an embedding endpoint of the text generation model; and
receipt of the first function call metadata from the embedding endpoint of the text generation model in response to the one or more numerical vectors.

19. The medium of claim 17, the program code executable by at least one processing unit of a computing system to cause the computing system to:
transmit the user prompt and the second response to the text generation model;
receive a query result from the text generation model in response to the user prompt and the second response; and
present the query result to the user.

20. The medium of claim 15, the program code executable by at least one processing unit of a computing system to cause the computing system to:
transmit the user prompt and the response to the text generation model;
receive a query result from the text generation model in response to the user prompt and the response; and
present the query result to the user.
